(19) United States
(12) Patent Application Publication
(10) Pub. No.: US 2015/0245088 A1
(43) Pub. Date: Aug. 27, 2015

(54) INTELLIGENT REMOTE CONTROL FOR DIGITAL TELEVISION

(71) Applicant: IFEELSMART, Paris (FR)

(72) Inventors: Xavier Bringue, La Garenne Colombes (FR); Shy Shriqui, Paris (FR); Julien de Nadai, Courbevoie (FR)

(21) Appl. No.: 14/422,556

(22) PCT Filed: Aug. 9, 2013
(86) PCT No.: PCT/FR2013/051916

§ 371 Date: Feb. 19, 2015

(30) Foreign Application Priority Data
Aug. 20, 2012 (FR) 1257883

(51) Int. Cl. H04N 21/422; H04N 21/442

(52) U.S. Cl. CPC H04N 21/4222; H04N 21/44231

(57) ABSTRACT

Television system comprising a television associated with a decoder and at least one remote peripheral comprising a viewing screen, and control means as well as means of digital dialogue between the peripheral and the television or the decoder, the peripheral comprising means of remote control of at least one function of the television or of the decoder and means of viewing of at least one content originating from the television characterized in that the functions associated with the means of control of the peripheral are of contextual type and are determined by information originating from the television or from the decoder.

### CROSS-REFERENCE TO RELATED APPLICATIONS

This application is a national phase entry under 35 U.S.C. §371 of International Patent Application PCT/FR2013/051916, filed Aug. 9, 2013, designating the United States of America and published as International Patent Publication WO 2014/029936 A1 on Feb. 27, 2014, which claims the benefit under Article 8 of the Patent Cooperation Treaty and under 35 U.S.C. §119(e) to French Patent Application Serial No. 1257883, filed Aug. 20, 2012, the disclosure of each of which is hereby incorporated herein in its entirety by this reference.

### TECHNICAL FIELD

The present invention relates to the field of television systems, generally consisting of a television set, a decoder and a remote control. The decoder can consist of independent equipment connected to the television set or be directly integrated into the television set. The invention relates more particularly to improving the interactions between the television set and the peripheral device.

### BACKGROUND

The patent application WO 2000/004709 is known in the prior art, which describes an interactive television program guide with remote access. The interactive television program guide is implemented on interactive television program guide equipment. A remote program guide access device is connected to the interactive television program guide equipment by a remote access link to provide a user with a remote access to program guide functions.

The international patent application WO 2000/059212 is also known, which relates to a new universal remote control system. Specifically, the remote control system of the prior art has the following features: bidirectional communications between the remote control and at least one of the audio/video devices, dual communication mode, automatic communication mode selection, loading and processing electronic program guide in the remote control, software graphical user interface in the remote control, expanding the television set functions by the remote control, calibration handshake between the remote control and the audio/video device, passive updating of the remote control, lost beacon signal in the remote control, handwriting recognition mechanism and voice recognition mechanism in the remote control.

The international patent application WO 98/43158 is also known, which describes a remote control comprising: a visual display, first wireless circuitry for receiving from a host device data in the form of selected information, e.g., an advertisement, to be displayed, stored or processed; second wireless circuitry for sending information; control circuitry and software for controlling operation of the remote control. Such software includes a display default routine for returning to the display of the selected information received by the first wireless circuitry.

The EP2148308 and US 2006/0028830 patent applications are also known in the prior art, which describe programmable remote controls. These solutions of the prior art relate to remote controls that can be configured by external equipment, separate from the television set or the decoder, for instance, a computer. This prohibits any contextual interactivity between the remote control and the television set (or the associated decoder).

In the documents of the prior art, the remote control is configured via a link between the remote control and a computer.

When the configuration is completed, the connection between the remote control and the computer is terminated, and the remote control is connected to a television set (or a decoder), which is the “slave” of the remote control. The television set has no means to provide information to the remote control in the situations described in the D1 and D2 documents.

### Drawbacks of the Prior Art

The solutions of the prior art are limited, as far as their utilization is concerned. The television set is the “slave” of the remote control, which is intended to transmit predetermined commands to drive some of the functionalities of the television set only. The information transmitted by the television set to the remote control in some of the solutions of the prior art is passive only.

### BRIEF SUMMARY

To remedy such drawbacks and provide a new solution best suited to the evolution of television sets in the digital context, the present invention, in its broadest sense, relates to a television system comprising a television set associated with a decoder and at least one remote peripheral device comprising a viewing screen, and control means as well as means of digital dialogue between the peripheral device and the television set or the decoder, with the peripheral device comprising means of remote control of at least one function of the television set or decoder and means of viewing at least one content originating from the television set characterized in that the functions associated with the means of control of the peripheral device are of contextual type and are determined by information originating from the television set or from the decoder.

In the invention, the exchanges between the television set and the remote control are dynamic, with each peripheral device being the master in some situations and the slave in other situations.

The two devices, the television set and the remote control, bidirectionally communicate, with each one having the capacity to dynamically drive some functionalities of the other device.

According to the present invention, the television set sends its state to the remote control, in real-time, and the remote control will dynamically modify its control modes according to the state indicated by the television set. The two devices, the television set and the remote control, bidirectionally communicate, with each one having the capacity to dynamically drive some functionalities of the other device.

Advantageously, the peripheral device further comprises an area for the synchronous viewing with the active contents on the television set or the decoder.

The television set preferably comprises a memory for saving at least one library of configuration data and means for transmitting the configuration data to a peripheral device so as to change the operation of the peripheral device according to the context of the television set.

In a first alternative solution, the configuration data is able to configure the graphic user interface of the peripheral device.

In a second alternative solution, the configuration data is able to configure the functions associated with the control means of the peripheral device.

According to a particular implementation, the system comprises a memory for saving a plurality of user profiles, and the configuration data is personalized by parameters associated with the active user profile.

Advantageously, the peripheral device comprises means for the processing and the representation of the media content from an external source, with the means being configured according to information originating from the television set or the decoder.

In a preferred alternative solution, the system comprises means for executing a step of matching requiring the physical proximity between the user, the peripheral device and the television set.

The system according to the invention preferably comprises means for exchanging information from the peripheral device to the television set having a TCPI/IP transport layer and a physical channel of the WIFI or mobile cellular network types with a protocol so configured as to enable the television set to push information to the connected peripheral device(s).

Advantageously, the television system according to the invention comprises means for synchronizing the metadata between the television set and the peripheral device.

### BRIEF DESCRIPTION OF THE DRAWINGS

The invention will be better understood upon reading the following description, which relates to a non-restrictive exemplary embodiment illustrated by the appended drawings wherein:

FIG. 1 shows an example of libraries of messages transmitted by the television get to the peripheral device;

FIG. 2 shows a schematic view of the software architecture of the application executed by the peripheral device;

FIG. 3 shows exemplary views of the screen of the peripheral device, in two consecutive states;

FIG. 4 shows the state diagram of such synchronization mechanism; and

FIG. 5 shows a schematic view of the architecture of the television set.

### DETAILED DESCRIPTION

The system according to the invention implements a television set associated with a decoder and one or more remote control peripheral device(s).

In the following part of the description, the term “television set” without any further indication, will refer to the television set as well as the associated decoder, with the latter being optionally integrated into the television set or connected to the television set as accessory equipment.

The remote control peripheral devices may consist of dedicated equipment or equipment such as a cell phone or a tablet wherein dedicated software has been downloaded.

The peripheral device makes it possible to control the functions of the television set and/or the decoder, such as channel switching, orders for video on demand, online ordering and social networks when the decoder or television set comprises means for interacting with the internet, or more generally, to control all the functions available on the television set and the decoder.

### Protocol and Means of Communication Between the Peripheral Device and the Television Set

The exchange of information from the television set to the peripheral device is provided according to the http protocol, with a transport layer and a physical channel enabling the transfer of a video stream. The transport layer is of the TCP/IP type and the physical channel is of the WIFI or mobile cellular network types, as a preferred, but not restrictive example.

The exchange of information from the peripheral device to the television set is provided by a different means, i.e., a proprietary (and not http) protocol, with a TCPI/IP transport layer and a physical channel of the WIFI or mobile cellular network types.

The proprietary protocol differs from the http protocol, which is limited to requesting, in that it enables the performance of “push” type actions.

The protocol for the exchanges of information from the peripheral device to the television set comprises functions enabling the television set to push information to the connected peripheral device(s).

For this purpose, the proprietary protocol comprises means for opening a TCP/IP communication channel (“socket”) between the peripheral device and the television set.

When this socket is created and the television set must send an event to the peripheral device, the protocol makes it possible to send the peripheral device a sequence containing the designation of the event in the form of a string of characters belonging to a predefined language.

For example, the message transmitted by the television set is of the “Séparateur début de message_changement de chaine_n° de chaine_Séparateur de fin de message” (“Start of message Separator_channel switch_channel number-end of message Separator”) type.

Such an event makes it possible to inform the peripheral device of the television set state, in real time.

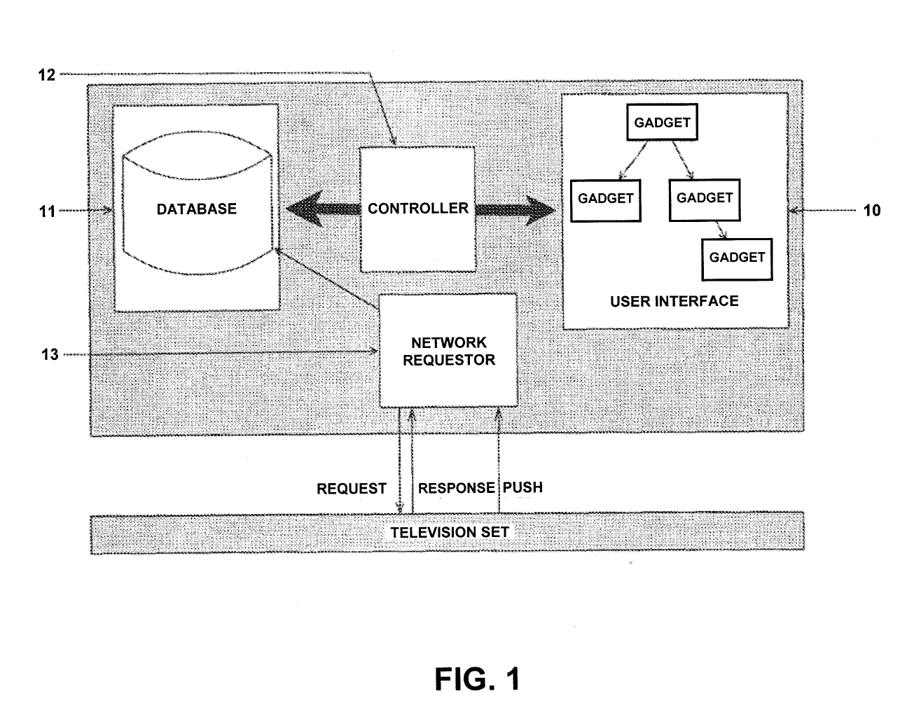

FIG. 1 shows an example of messages libraries.

A programming interface (API) of the REST (Representational State Transfer) type makes it possible to define a sub-language corresponding to four actions:
inquiring;
editing;
adding; and
deleting.

These actions are associated with standard functionalities of the http protocol, i.e.:
get;
post;
put; and
delete.

These language commands are applied to act on the contents represented by URLs. For example, an electronic program guide (EPG) will be inquired for a given time by sending an “inquiring” command associated with the “get” command of the http protocol, followed by the URL corresponding to the program guide, with the time in question and, where appropriate, the corresponding channel as parameters.

This command will be, for example, of the following type:

“Get/epg?channel=n&date=hhddmmyy.”

### Matching

To enable communication between the peripheral device and the television set, the invention provides a step of matching that requires the physical proximity between the user, the peripheral device and the television set. This step is executed at least upon the first powering on, or upon each resetting of the system.

This step of matching is initiated by the television set from the usual remote control or the direct commands thereof. The first action consists of controlling an audio mode for the television set, wherein the latter is passive to receive information from an external peripheral device and display matching information on the display screen:
the IP address; and
a token represented, for example, by a series of hexadecimal characters.

Such information may also be grouped into a graphic code, for example, a QR code, or a sound token.

This information has a limited life of a few seconds.

Such information is then entered by the user into the peripheral device, either manually or by acquisition from a camera integrated in the peripheral device, in the case of a graphic code, or using a microphone for a sound token.

When such matching information is entered into the peripheral device, the latter sends a request containing the information to the television set using the communication channel provided between the peripheral device and the television set.

This step makes it possible to check the physical presence of the peripheral device near the television set. If the time elapsed from the reporting of the matching information to the sending by the peripheral device of the entered information exceeds a threshold value, or when the two items of information are different, the television set displays error information and does not approve the matching.

If both items of information are complying and processed within the lifetime of the token, the matching procedure continues with a step of encrypted emission of a second token, which may be a matching key, and of saving the identifier of the peripheral device and the matching information into a database.

The peripheral device saves the second token in a local memory, and the matching operation is then completed.

In addition, when initializing a new system, the system comprises a default user identifier. At least one user personal identifier and possibly the profiles associated therewith may be saved in a database of the television set at any time.

Any request exchanged subsequently between the peripheral device and the television set will be signed by the second token.

### User Identification

Each user of the matched peripheral device will be personally identified via a procedure of the “login” type.

The peripheral device makes a request to retrieve the list of the profiles saved in the aforementioned database, and displays a list of saved profiles or users on the screen of the peripheral device and/or the television set. The user then selects one of the elements, or decides to create a new one.

This step leads to the personalization of the utilization according to the profile associated with the selected user:
channels that can be activated;
parental control;
active social networks and parameters of the social networks based on the user's identifier;
access to functions such as order for pay content or access to the Internet;
personalized settings (favorites, favorite channels, language, type, etc.); and
content recommendation profile.

### Architecture and Operation of the Peripheral Device

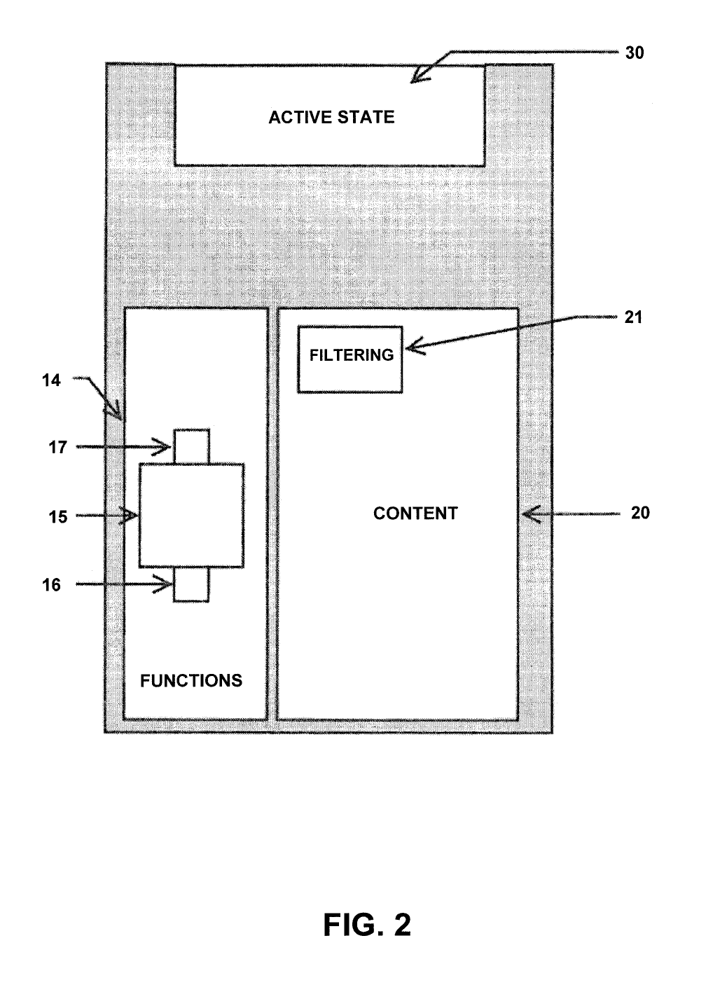

FIG. 2 shows a schematic view of the architecture of the peripheral device.

The peripheral device comprises a computer 1 and a memory 2 for saving the means for driving the functions of display on a screen 3, e.g., a touch screen and the control functions.

If no matched television set has been recognized, the display screen 3 shows the matching interface.

When a matched television set is recognized and the user identified, the peripheral device displays the functions available to control the television set for the selected user (according to his/her profile) in the form of icons.

For each one of the selected functions, a list of content is displayed, according to the user's profile.

Each one of such contents provides a list of actions:
watch;
buy;
save; or
send to the television set, etc.

These actions are linked to the type of media, the user's profile and the mode of connectivity between the television set and the peripheral device.

In addition, the graphic interface permanently displays, in a reserved display zone, a representation of the active state of the television set, for instance, as a video display of the viewed stream, or a part of the stream or still a part of the metadata thereof (channel or program logo, program title, etc.).

Such information is transmitted to the peripheral device by the television set via the API requests.

For this purpose, the television set transmits to all the peripheral devices connected messages relating to any change in its state (e.g., channel switching, program switching, opening or closing of an application, etc.) as pushed messages.

### Technical Architecture of the Peripheral Device

The peripheral device is a mobile equipment such as a cellular phone or a tablet provided with connection means of the WIFI and/or cell types for transmitting multimedia streams, a screen and control means, for example, a touch screen.

Specific software is installed in this peripheral device, through downloading from an application platform, for example, or it is pre-installed on a dedicated peripheral device.

Such software is executed on the computer of the peripheral device and controls the interactions with the physical (screen, keyboard, etc.) or digital (communication bus, memory, etc.) input/output means.

FIG. 2 shows a schematic view of the software architecture of the application executed by the peripheral device. This application controls:
the user interface 10 of the peripheral device for the display of information;
the database 11 for the local storage of information in the memory of the peripheral device;
the controller 12 determining the association of functions with graphic representations and the access to data and multimedia streams, based on the user's inputs; and
the requestor 13 controlling the interactions with the television set and the exchange of data between the peripheral device and the television set.

The user interface 10 is started on the peripheral device upon activation of the remote control application. Depending on the operating system (Android, Ios, Windows, etc.), such functionality is implemented in a manner known in the art.

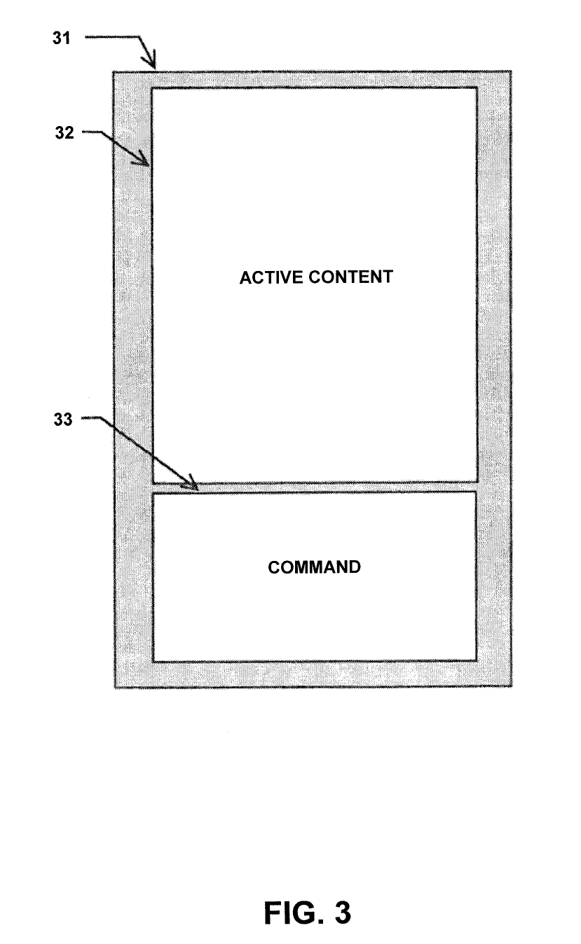

The user interface 10 controls the display on the screen of which FIG. 3 shows an exemplary view, of different zones:
a first zone 14 displaying graphic icons as a scrolling roll, where each icon is associated with the main active functions;
a “Video On Demand (VOD)” icon 15 associated with the catalog of video on demand contents;
a “live TV” icon 16 associated with the program guide;
a “catchup” icon 17 associated with the catalog of the played channel contents, etc.; and
a second content display zone 20, the content of which dynamically varies according to the selected icon, to represent the available content as images or a video sequence, or even textual or graphic metadata.

Each one of such contents can be activated by a touch selection, which triggers a detailed view of the selected content as an image, a video or a text having larger dimensions, optionally together with a comment as well as the display of a contextual list of functions associated with the selected content (for example, “play on the television set,” “save,” “share,” “play on the peripheral device,” etc.). If applicable, activating some icons commands an exchange between the peripheral device and the television set, for example, to select some content on the television set and control the playback thereof on the television set. Optionally, some functions will activate the opening of a screen for conversing with a text input zone or commands specific to the selected function (for instance, entering an email or social network address to share some commented content).

This second zone 20 comprises a filtering and/or sorting mechanism that may be activated by a touch button 21 that controls the sequence and the nature of the display.

A third display zone 30 for showing information and functionalities of bidirectional exchange between the television set and the peripheral device is also provided.

A first category of communication refers to the “television set to the peripheral device” direction. It relates to the display, in this third zone 30, of video, text and/or image information corresponding to the content being displayed on the television set, with the possibility to scroll, over a wide zone 31, additional information and contextual functions so as to directly control the television set, and more particularly to change the content being displayed. Icons and contextual functions relating to the nature of the stream shown on the television set will be displayed in this zone 31; they will be different when the stream is of the “video on demand” or “broadcast channel” or “application” types. This zone also makes it possible to display a specific signal linked with the interactivity routine of the television channels of the HBB type or interactive advertisements. In this case, the information received on the television set is displayed while emphasizing the display zone 30 (highlighting, flashing, etc.) so as to enable the execution of the interactive function directly on the peripheral device.

The remote control has an active viewing zone shown as a status bar 30. Such zone 30 first displays graphic information corresponding to a notification sent by the television set to the remote control. This notification is emitted by the television set when the content displayed on the television set comprises an interaction marker (of the Hbbtv type). This marker is for example:
a URL refers to a vote calling service;
a URL refers to an interactive advertisement service; and
a URL refers to an interactive sports betting service, etc.

The remote control user may decide to execute the service shown in the display zone 30. In this case, the service is executed on the remote control as a third party service, in the application downloaded into the remote control, or in an application residing in the remote control (for example, launching of a web browser opening the site corresponding to the URL associated with the marker).

In addition, the user can act on the zone 30, for example, by an action of the “pull” or “open” types, to control the sending of contextual information by the television set at any time and without any specific notification. This action causes the display of a large zone 31 enabling him/her to view content (active content zone 32) and actions applicable to the content displayed on the television screen (display zone 33).

Such contextual information is regularly updated. The contents are determined by the contents being viewed on the television set. They may be a graph, a video, or a text. They are updated each time the context of the television set changes.

These actions are linked to the content displayed on the television screen; they permanently reflect the state of the controlled television set by a periodic exchange of information between the television set and one or more remote control(s) controlling the television set, by receiving information on the television set state.

Several contexts simultaneously displayed on the same television set (for instance, a video stream and an application) can be controlled with a single remote control that processes each context individually. The user can switch from one context to another.

In the extended display zone 31, several contents can be displayed, especially when several contents are shown on the television set (for instance, a direct stream plus one application).

A second category relates to the “peripheral device to television set” direction; it makes it possible to control changes in the content displayed on the television set, depending on the different content displayed on the peripheral device screen, by a gesture of the “drag and drop” type. This gesture consists of selecting one of the display thumbnails of some available content and moving it to the third zone 30. The arrival thereof in the third zone 30 triggers the contextual action of controlling the television set to display the content on the television set, for example, or launching the application on the television set, or opening a sequence for the purchase of a content not available on the television set.

The infographics of display on the peripheral device can be personalized, more particularly, using a mechanism of adaptation to the interface of the television set and/or a service operator from a configuration file exchanged between the television set and the peripheral device.

The management of the database 11 aims at locally saving some of the contents in order to improve the flow of displays in the memories of the peripheral devices. These contents are contextually buffered (cache), according to the content viewed as well as content very likely to be viewed in the future.

The controller 12 aims at retrieving data saved in the database and at controlling the display thereof on the screen of the peripheral device in one of the above-mentioned zones.

The requestor 13 aims at emitting request to the television set, so as to retrieve data required to display content on the peripheral device. The information thus retrieved is saved in the database 11.

### Data Synchronization

The television set transmits a video stream according to a standard format to the connected peripheral devices, with the peripheral device comprising a player for decoding and playing the video content. According to an alternative solution, the peripheral device comprises independent and comprehensive means for receiving and decoding streams, controlled by information of the metadata type pushed by the television set. Such metadata is used to control the selection of the stream to be displayed on the peripheral device screen and the starting of the sequence to be viewed, so as to create a mirror of the stream displayed on the television set.

To enable a smooth flowing of the information displayed on the peripheral device, the invention provides steps of synchronizing the metadata between the television set and the peripheral device.

Synchronization implements two types of mechanisms:

The first mechanism relates to the requests, by the interface, for some data that is not locally available or that is locally available in an outdated form (recording date exceeding a predetermined period of validity). In this case, the requester commands the updating of the local data requested from the data available on the television set.

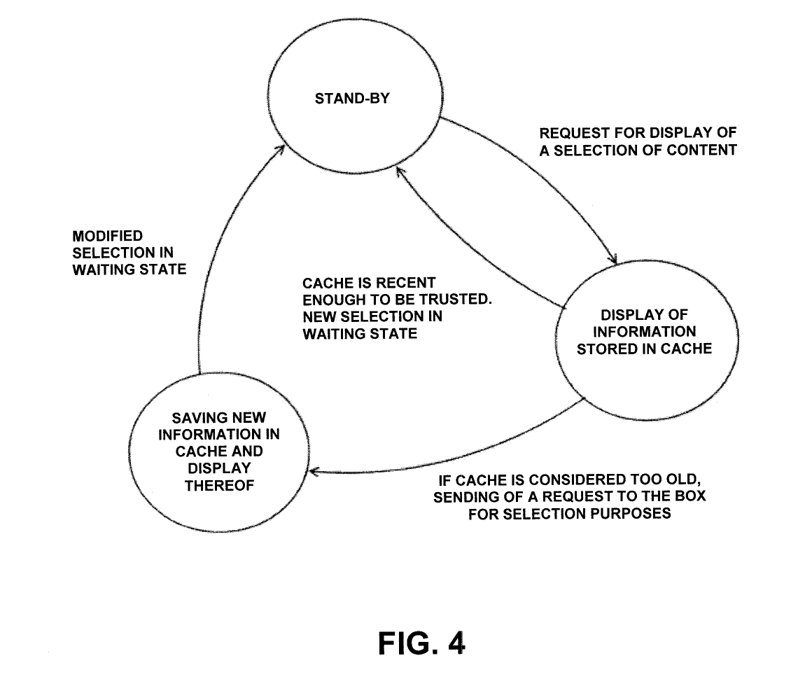

FIG. 4 shows the state diagram of such synchronization mechanism illustrating the various states of this mechanism. The synchronization mechanism is started in a state awaiting a request for synchronization.

When such a request is emitted by a software component of the controller, for example, when a function is selected by the user, the mechanism commands the display of the information available in the local database of the peripheral device and simultaneously tests the validity of the local data by checking the recording dates in the local database and the date of the latest recording in the database of the television set.

If the local data has been updated, the mechanism returns to the standby position.

If the local data has not been updated, the mechanism triggers an import of the data available in the database of the television set and controls the display thereof on the peripheral device.

The second mechanism operates in the background. At regular intervals, the requestor commands the updating of some parts of the database.

### Software Architecture of the Television Set

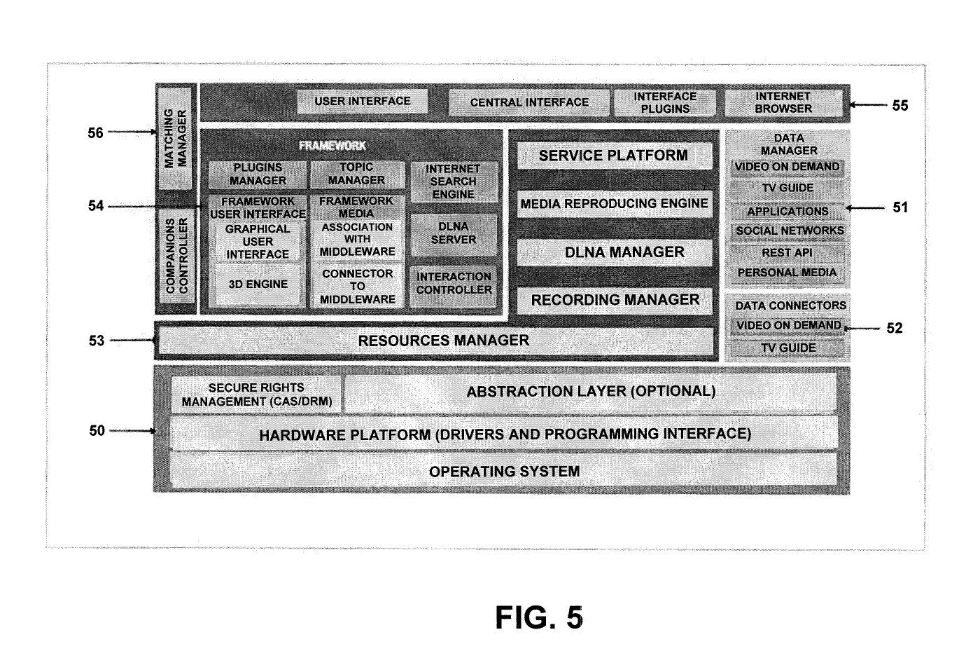

FIG. 5 shows a schematic view of the software installed on the television set.

The architecture comprises:
a physical layer 50 for physical and digital connections;
“data” layers 51, 52 for data from external servers;
middleware layers 53 for managing the content playback and display functions;
layers of structural software components (“framework”) 54 enabling the execution of the specific functionalities not supported by the middleware layers, and the execution of the functionalities of the 3D rendering engine;
an interface layer 55 for the management of the user interface on the television set display; and
a dialogue layer 56 dedicated to external peripheral devices for managing the exchanges between the peripheral device and the television set.

The dialogue layer 56 commands the execution of the various routines of matching of the peripheral devices, of dialogue between a peripheral device and the television set, of synchronizing data, and controls the exchange of information between the peripheral device and the other layers 50-55, in particular, with the layer of structural software components 54.

1.-11. (canceled)

12. A television system, comprising:
a television set;
a decoder associated with the television set; and
at least one remote peripheral device, the remote peripheral device including:
a viewing screen;
control means for remotely controlling at least one function of the television set or the decoder, wherein the at least one function controllable by the control means is of a contextual type and determined by information originating from the television set or from the decoder;
means for digital dialogue between the at least one remote peripheral device and the television set or the decoder, and
means for viewing at least one content originating from the television set on the viewing screen.

13. The television system of claim 12, wherein the at least one remote peripheral device further comprises an area for a synchronous viewing of active content of the television set or the decoder.

14. The television system of claim 12, wherein the television set comprises:
a memory storing at least one library of configuration data; and
means for transmitting the configuration data to the at least one remote peripheral device so as to change operation of the at least one remote peripheral device according to context of the television set.

15. The television system of claim 14, wherein the configuration data is used to alter a graphic user interface of the at least one remote peripheral device.

16. The television system of claim 14, wherein the configuration data is able to configure the at least one function of the television set or the decoder.

17. The television system of claim 14, further comprising memory for storing a plurality of user profiles, and wherein the configuration data is personalized by parameters associated with an active user profile of the plurality of user profiles.

18. The television system of claim 12, wherein the at least one remote peripheral device comprises means for processing and representation of media content originating from an external source, wherein the means for processing and representation of media content are configured according to information originating from the television set or the decoder.

19. The television system of claim 12, wherein an information communication protocol used to communicate information from the television set to the at least one remote peripheral device comprises means for pushing a message to the at least one remote peripheral device from the television set.

20. The television system of claim 1, further comprising means for executing a step of matching requiring physical proximity between a user, the at least one remote peripheral device, and the television set.

21. The television system of claim 12, further comprising means for exchanging information from the at least one remote peripheral device to the television set including a TCPI/IP transport layer and a physical channel of the WIFI or mobile cellular network types, with a protocol configured so as to enable the television set to push information to the at least one remote peripheral device.

22. The television system of claim 12, further comprising means for synchronizing metadata between the television set and the at least one remote peripheral device.

23. A television system, comprising:
a television set;
a decoder associated with the television set; and
at least one remote peripheral device configured to exchange digital data with at least one of the television set and the decoder, the remote peripheral device including:
a viewing screen, wherein at least a portion of the viewing screen is configured for viewing content originating from the television set; and
a control device configured for remotely controlling at least one contextual function of at least one of the television set and the decoder, wherein the at least one contextual function is determined by information originating from at least one of the television set and from the decoder.

24. The television system of claim 23, wherein the at least one remote peripheral device comprises a dedicated remote control.

25. The television system of claim 24, wherein the television set and the remote control are configured to bidirectionally communicate with one another, each of the television set and the remote control having the capacity to dynamically drive a functionality of the other of the television set and the remote control.

26. The television system of claim 25, wherein the television set is configured to send information indicating an operational state of the television set to the remote control, and the remote control is configured to dynamically modify a control mode of the remote control according to the operational state of the television set.

27. The television system of claim 25, wherein the remote control further comprises an area configured to synchronously view active content displayed on the television set.

28. The television system of claim 23, wherein the at least one remote peripheral device comprises a cell phone or a tablet computer.

28. The television system of claim 23, wherein the television system is configured to transmit information from the television set to the at least one remote peripheral device according to http protocol, and to transmit information from the at least one remote peripheral device to the television set using a non-http protocol enabling push of information

29. The televisions system of claim 28, wherein the non-http protocol is configured to enable opening of a TCP/IP communication channel socket between the at least one remote peripheral device and the television set.

30. The television system of claim 12, wherein the television system is configured to synchronize metadata between the television set and the at least one remote peripheral device.
